(19) United States
(12) Patent Application Publication
(10) Pub. No.: US 2026/0241766 A1
(43) Pub. Date: Aug. 20, 2026

(54) HYBRID BELLOWS FOR A HEIGHT ADJUSTMENT DEVICE OF A VEHICLE

(71) Applicant: Vibracoustic SE, Weinheim (DE)

(72) Inventors: Ersan Altinoluk, Hamburg (DE); Dieter Bulling, Wedemark (DE)

(21) Appl. No.: 19/310,234

(22) Filed: Aug. 26, 2025

(30) Foreign Application Priority Data
Aug. 27, 2024 (DE) 10 2024 124 386.4

(51) Int. Cl. B60G 17/08

(52) U.S. Cl. CPC B60G 17/08; B60G 2202/24; B60G 2206/7101; B60G 2206/73

(57) ABSTRACT

The invention relates to a hybrid bellows for a height adjustment device of a vehicle. In embodiments the device includes a multi-layered main body with a first free end and a second free end and with a working chamber which can be shaped between the free ends. The main body may have an inner elastomer layer facing the working chamber and an outer elastomer layer facing an environment. With embodiments, the inner elastomer layer has a first material composition and the outer elastomer layer has a second material composition. With implementations, a hybrid bellows may be characterized as having a first material composition and the second material composition that differ from one another. The invention further relates to an apparatus for the height adjustment of a vehicle that includes a hybrid bellows.

### CROSS-REFERENCE TO RELATED APPLICATION

This application claims priority to German Patent Application No. DE 10 2024 124 386.4, filed on Aug. 27, 2024, the contents of which is hereby incorporated by reference in its entirety.

### TECHNICAL FIELD

The invention relates to a hybrid bellows for an apparatus for the height adjustment of a vehicle and an apparatus for the height adjustment of a vehicle comprising such a hybrid bellows.

### BACKGROUND

Apparatuses for the height adjustment or leveling of motor vehicles are used in order to vary the level of a vehicle or a driver's cab in an adjustable manner, or to keep the level constant in the case of variable loading. The adaptation of the level is achieved by changing a pressure in a working chamber of the apparatus which is sealed in a fluid-tight manner, wherein the pressure is changed by supplying a suitable working medium into the working chamber or by draining the working medium out of the working chamber.

To this end, conventional apparatuses have a bellows made of an elastomer material which together with a cover element and a rolling piston forms the working chamber. Compressed air is frequently used as the working medium. For the leveling, the bellows rolls up or unrolls with at least one rolling fold as a function of the pressure in the working chamber along the outer surface of the rolling piston and thereby changes its height.

Bellows known from the art are generally constructed in multiple layers, wherein a central reinforcing layer which comprises a single layer or a plurality of layers of rigidity supports embedded in an elastic matrix is covered in each case on both sides by an elastomer layer-i.e. inwardly to the working chamber and outwardly to the ambient air.

Such a bellows is described, for example, in EP 4 077 517 A1. The working medium used therein, however, is compressed air which is why the requirements for the inner elastomer layer are substantially the same as the requirements for the outer elastomer layer. As a result, the elastomer layers used therein are constructed in each case from the same rubber mixture.

In bellows of hydraulically operating systems, however, the working chamber is filled with a fluid medium instead of compressed air. Depending on the field of application, different media can be used, such as for example water, glycols, oils, brake fluids or mixtures of the aforementioned substances. These fluid media apply stress to the inside of the bellows to a different degree compared to air, for example, which can lead to a premature failure of the inner elastomer layer-namely due to the premature occurrence of cracks in the inner layer.

### SUMMARY

It is thus an aspect of the disclosure to address conventional drawbacks and to provide a hybrid bellows for an apparatus for the height adjustment of a vehicle which may exhibit improved service life.

Aspects and features of the concept are disclosed herein.

Various aspects of the disclosure may be achieved by a hybrid bellows for a height adjustment device of a vehicle, wherein the hybrid bellows comprises a multi-layered main body with a first free end and a second free end and with a working chamber which is to be or can be shaped or built between the free ends, wherein the main body has an inner elastomer layer facing the working chamber and an outer elastomer layer facing an environment, and wherein the inner elastomer layer has a first material composition and the outer elastomer layer has a second material composition. With embodiments, a hybrid bellows may have a first material composition and a second material composition that differ from one another. Such a bellows may thus not comprise “a single type” of elastomer material.

“Working chamber” is to be understood to mean the region of the hybrid bellows which, when the bellows is used as intended, is located between the connecting point of the first free end to the rolling piston and the connecting point of the second free end to a cover element, or the like.

A hybrid bellows designed in such a manner may be suitable for hydraulically operating systems, since the inner and the outer elastomer layer of the bellows can be adapted in each case to their respective contact media. The medium which is respectively in contact with the outer layer or with the inner layer of the bellows is denoted as the contact medium. In the case of the outer layer, the contact medium is generally air; the contact medium of the inner layer, in particular, is an incompressible fluid medium. As a result, a material composition which provides the layer with a particular resistance relative to the ambient air can be selected for the outer elastomer layer. Moreover, the material composition of the outer layer can be selected such that it withstands further environmental influences, for example heat, cold or ozone. The inner layer of the bellows can comprise a material composition which is resistant relative to the respective fluid in the working chamber. The material composition of the inner layer is denoted in the context of this disclosure as the “first material composition” and the material composition of the outer layer may be denoted as the “second material composition”. As the first and second material composition of the bellows may be adapted in each case to their respective contact media, the risk of damage to or wear of the hybrid bellows due to chemical degradation may be reduced or minimized.

According to a development, it can be provided that the working chamber is filled with a fluid when the hybrid bellows is used as intended. The working chamber may be, in particular, fluid-tight. In this manner, it is possible to prevent an undesired exit of the fluid from the working chamber. At the same time, an undesired entry of air into the working chamber from the external environment may also be prevented.

According to a development, the fluid in the working chamber may be selected from the group comprising brake fluids, oils, in particular hydraulic oils, coolants, glycols and glycol-water mixtures. It may be advantageous when fluids are selected which are used in any case for the specific vehicle, since this does not result in any greater maintenance effort.

According to a development, it can be provided that the second material composition comprises an elastomer which is selected from the group comprising natural rubber, polybutadiene rubber (“BR”), acrylonitrile butadiene rubber (“NBR”), hydrogenated acrylonitrile butadiene rubber, silicone or ethylene propylene diene monomer rubber (“EPDM”). The aforementioned materials may have high resistance to oil and/or glycol-containing liquids. BR is characterized by a high degree of elasticity and very good low-temperature properties due to its low glass transition temperature. NBR has polar groups which interact only minimally with non-polar liquids such as benzine, oil or fats, so that the material does not swell after contact with these media. EPDM is resistant to temperatures of up to 150° C. The material is also resistant to polar substances. Advantageously, the first and second material compositions should be selected such that they can be designed to adhere to one another. If an intermediate layer with a third material composition is used, the first and second material compositions should be selected such that they can be arranged in each case to adhere to the third material composition.

According to a development, it can be provided that the first material composition comprises chlorobutadiene rubber-based elastomers (“CR-based elastomers” or “CR elastomers”). CR-based elastomers may be robust relative to external environmental influences and thus well suited to use in the outer elastomer layer. In addition, there are many years of experience of using CR-based elastomers in bellows, so that their properties can be easily predicted and/or simulated in the design.

According to a development, it can be provided that the main body has a reinforcing layer arranged between the inner elastomer layer and the outer elastomer layer. The reinforcing layer stabilizes the hybrid bellows. In this manner, an unreinforced sealing bellows may withstand high pressures without deforming or tearing to an undesired degree.

According to a development, it can be provided that the reinforcing layer comprises an elastomer matrix and at least one rigidity support layer, wherein the at least one rigidity support layer is at least partially embedded in the elastomer matrix. According to a development, in particular, it can be provided that the reinforcing layer has two rigidity support layers which are at least partially embedded in the elastomer matrix. The use of a plurality of rigidity support layers may provide a higher degree of stability and a lower weight.

According to a development, it can be provided that the elastomer matrix has a third material composition. According to a development, it can also be provided that the third material composition is substantially identical to the first material composition or that the third material composition is substantially identical to the second material composition. As a result, the production of the bellows is simplified, since the same apparatuses or at least parts thereof can be used for producing the elastomer of the reinforcing layer as for producing the inner or the outer elastomer layer. However, it is also conceivable that the third material composition differs from the first and from the second material composition.

According to a development, it can be provided that each rigidity support layer comprises a plurality of rigidity supports. According to a development, it can be provided that the rigidity supports are preferably fibers, yarns or filaments made of polyamide and/or polyester or a woven fabric made of polyamide and/or polyester. The use of such a fiber reinforcement has proved to be particularly suitable since as a result the hybrid bellows has a high degree of stability with a low weight and since its flexibility is limited to the flexibility of the fibers in the fiber direction. As a result, the bellows can be produced simply and cost-effectively. In the context of this disclosure, the terms “fiber”, “yarn” and “filament” are used synonymously, provided this is not contradicted by the respective context. All of the terms denote substantially elongated structures made of natural or synthetic substances, wherein the natural fibrous materials can have a plant, animal or mineral origin and wherein the synthetic fibrous materials comprise, in particular, polymers.

According to a further aspect, the disclosure may relate to a height adjustment device for the height adjustment of a vehicle, comprising two hybrid bellows according to this disclosure. The height adjustment device also comprises a first wall element and a second wall element axially spaced apart from the first wall element, wherein the first wall element, the second wall element and the hybrid bellows form the working chamber. To this end, the free ends of each hybrid bellows are fastened to the first or to the second wall element, for example via clamping rings. Such a height adjustment device is particularly long-lasting since the elastomer layers which are applied on the inner or on the outer reinforcing layer side can be adapted to their respective contact media, whereby a high degree of chemical resistance is achieved.

According to a development, it can be provided, in particular, that the height adjustment apparatus is a hydraulic height adjustment device. The hybrid bellows defines the pressurized working chamber, wherein the bellows forms a rolling fold. A change in pressure in the working chamber results in a change in volume which in turn leads to a movement of the bellows in the rolling fold and thus to an adaptation of the vertical position of the vehicle.

According to a development, the height adjustment device is a base point adjustment device for a spiral spring in a chassis of a motor vehicle.

According to a further aspect, the disclosure may relate to a system for the height adjustment of a vehicle, comprising a height adjustment device according to this disclosure, a first spring support, a second spring support and a spring arranged between the first spring support and the second spring support.

### BRIEF DESCRIPTION OF THE DRAWINGS

Further features, details, and advantages of the invention are found in the wording of the claims and in the following description of exemplary embodiments by way of the drawings, in which:

FIG. 1 shows a schematic cross section through the main body of a hybrid bellows according to a first embodiment;

FIG. 2 shows a schematic cross section through the main body of a hybrid bellows according to a second embodiment;

FIG. 3 shows a schematic cross section through the main body of a hybrid bellows according to a third embodiment;

FIG. 4 shows a system for the height adjustment of a vehicle according to one possible embodiment.

### DETAILED DESCRIPTION

In the figures, elements which are the same or correspond to one another are denoted in each case by the same reference signs and thus, if not appropriate, may not be described again. Features which have been already described may not be described again in order to avoid repetition, and can be applied to all elements with the same reference signs or reference signs corresponding to one another, if not explicitly excluded. The disclosures contained in the entire description are expediently transferrable to the same parts with the same reference signs or the same component designations. The positional information selected in the description, such as for example top, bottom, side, etc. refers to the figure directly described and shown, and in the case of a change in position can be transferred expediently to the new position. Moreover, individual features or combinations of features from the different exemplary embodiments shown and described can also represent solutions which are independent, inventive or according to various aspects or teachings.

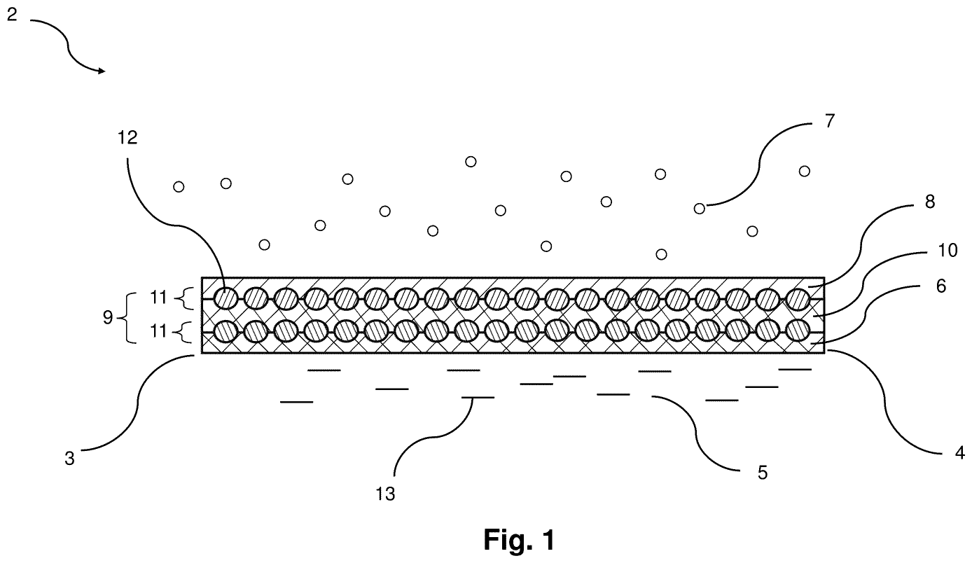

In FIG. 1 a schematic cross section is shown through the main body 2 of a hybrid bellows 1 according to one possible embodiment. The main body 2 has a first free end 3 and a second free end 4, wherein the two free ends 3, 4 can be connected in each case, for example, to a rolling piston and to a cover element (neither shown) and thus form a working chamber 5. The main body comprises an inner elastomer layer 6 facing the working chamber 5 and an outer elastomer layer 8 facing the external environment 7. The working chamber 5 is filled with a fluid 13.

The inner elastomer layer 6 has a first material composition and the outer elastomer layer 8 has a second material composition which differs from the first material composition. The difference in the two material compositions in the case of the example shown is represented by the different hatched lines of the elastomer layers 6, 8.

A two-layer reinforcing layer 9 is also arranged between the inner and the outer elastomer layer 6, 8. The reinforcing layer 9 shown in FIG. 1 thus has two rigidity support layers 11 which are embedded in a common elastomer matrix 10 of the reinforcing layer 9. Each rigidity support layer 11 comprises a plurality of yarn-like rigidity supports 12 which are preferably produced from polyamide and/or polyester. In the example shown, the third material composition of the elastomer matrix 10 of the reinforcing layer 9 is substantially identical to the first material composition of the inner elastomer layer 6 which is represented by the use of similar hatched lines. As a result, the production of the bellows 1 is simplified, since the reinforcing layer 9 can be applied together with the inner or elastomer layer 6 in the same working step.

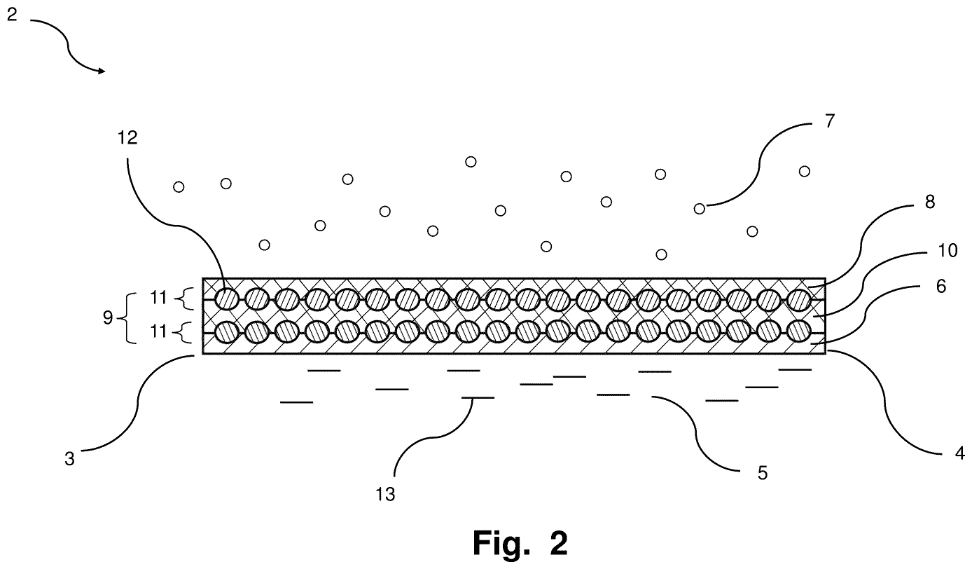

FIG. 2 shows a schematic cross section through the main body 2 of a hybrid bellows 1 according to a second embodiment. The hybrid bellows 1 shown in FIG. 2 primarily differs from the hybrid bellows 1 of FIG. 1 in that the third material composition of the elastomer matrix 10 of the reinforcing layer 9 is substantially identical to the second material composition of the outer layer 8.

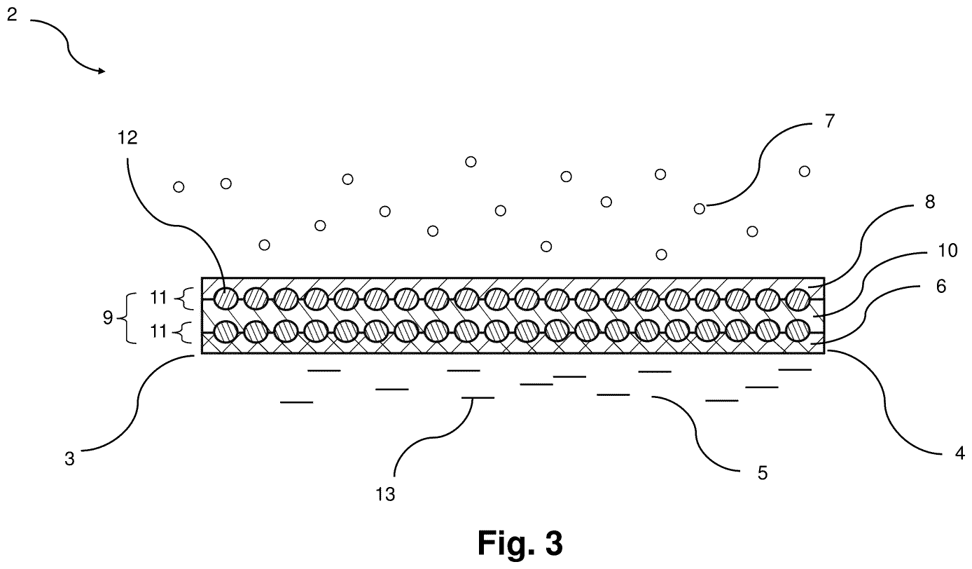

FIG. 3 shows a schematic cross section through the main body 2 of a hybrid bellows 1 according to a third embodiment. In the case of the example of FIG. 3, all three material compositions differ from one another. The elastomer matrix 10 of the reinforcing layer 9 accordingly has a different material composition from the inner layer 6 and the outer layer 8, which also differ from one another relative to their material compositions.

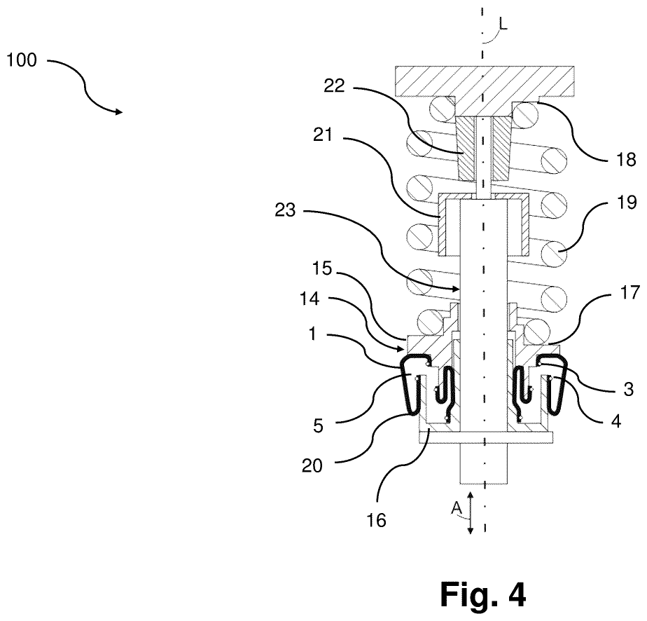

FIG. 4 shows a system 100 for the height adjustment of a vehicle according to one possible embodiment. The system 100 serves for damping and cushioning impacts of a motor vehicle and for levelling or height adjustment. For levelling the motor vehicle, the system has a height adjustment device 14 which in the case of FIG. 4 is a base point adjustment device. The height adjustment device 14 comprises a first wall element 15 and a second wall element 16 which are spaced apart from one another along a longitudinal axis L. The wall elements 15, 16 are connected together via two hybrid bellows 1 and enclose with the bellows 1, by forming a rolling fold 20, a variable fluid volume in a working chamber 5. To this end, the free ends 3, 4 of the hybrid bellows are fastened in each case to the first wall element 16 or to the second wall element 17. The second wall element 16 also functions as a first spring support 17 for a spring 19. The system 100 shown in FIG. 4 shows by way of example an intended use of the hybrid bellows 1 such as described herein.

The longitudinal axis L projects through the system 100, wherein the height adjustment also takes place in this direction. The illustrated system 100 comprises a damper 23 which in the example shown is a hydraulic damper. A stop cover element 21 is fastened to the hydraulic damper 23 on the front face. The damping rod protrudes from the damper housing on the same front face and is connected to a counter-bearing 18 which functions as second spring support.

The illustrated system 100 also comprises a spring 19 which is shown in FIG. 4 as a helical compression spring. The spring is supported at one end on the first spring support 17 and at the second end on the second spring support, wherein the first spring support 17 in the example shown is the upper face of the second wall element 15 and the second spring support 18 is the counter-bearing 18. An application of force on the height adjustment device 14 in the direction of the counter-bearing 18 or on the counter-bearing 18 in the direction of the height adjustment device 14 leads to the compression of the spring 19. In order to prevent an overload or even full compression of the spring 19, the illustrated system 100 also has a resilient additional spring 22. The additional spring 22 is arranged between the height adjustment device 14 and the counter-bearing 18. In addition, the additional spring 22 opposes the stop cover element 21 along the longitudinal axis L. As a result, the additional spring 22 can bear against the stop cover element 21 for limiting the spring path.

If the motor vehicle is loaded, the spring 19 flexes over a path according to the load and the motor vehicle is correspondingly lowered. This can be counteracted by the levelling in the form of the height adjustment device 14. In order to achieve the original level of the motor vehicle before loading, additional fluid 13 is pumped into the working chamber 5 of the height adjustment device 14, whereby the volume of the working chamber 5 is increased and whereby the second wall element 16 of the height adjustment device 14 and the base point of the spring 19 are displaced. The preloaded spring 19 is adjusted along the longitudinal axis L and pushes the counter-bearing 18 and thus also the motor vehicle to the original level.

The present disclosure is not limited to the above-described embodiments but can be modified in many different ways. In order to avoid repetition, features disclosed according to the apparatus are also intended to be applicable as disclosed according to the method. Features disclosed according to the method are also intended to be applicable as disclosed according to the apparatus.

All of the features and advantages found in the claims, the description, and the drawing, including structural details, spatial arrangements and method steps, may be implemented both individually and also in very different combinations.

1. A hybrid bellows for a height adjustment device of a vehicle, comprising a multi-layered main body with a first free end and a second free end and with a working chamber which is to be shaped between the first free end and the second free end, wherein the main body has an inner elastomer layer facing the working chamber and an outer elastomer layer facing an environment, wherein the inner elastomer layer has a first material composition and the outer elastomer layer has a second material composition, wherein the first material composition and the second material composition differ from one another.

2. The hybrid bellows as claimed in claim 1, wherein the working chamber is filled with a fluid when the hybrid bellows is used as intended.

3. The hybrid bellows as claimed in claim 2, wherein the fluid in the working chamber is selected from the group comprising brake fluids, oils, in particular hydraulic oils, coolants, glycols and glycol-water mixtures.

4. The hybrid bellows as claimed in claim 1, wherein the first material composition comprises an elastomer which is selected from the group comprising natural rubber, polybutadiene rubber, acrylonitrile butadiene rubber, hydrogenated acrylonitrile butadiene rubber, silicone or ethylene propylene diene monomer rubber.

5. The hybrid bellows as claimed in claim 1, wherein the second material composition comprises chlorobutadiene rubber-based elastomers.

6. The hybrid bellows as claimed in claim 1, wherein the main body has a reinforcing layer arranged between the inner elastomer layer and the outer elastomer layer.

7. The hybrid bellows as claimed in claim 6, wherein the reinforcing layer comprises an elastomer matrix and at least one rigidity support layer, wherein the at least one rigidity support layer is at least partially embedded in the elastomer matrix.

8. The hybrid bellows as claimed in claim 7, wherein the reinforcing layer has two rigidity support layers which are at least partially embedded in the elastomer matrix.

9. The hybrid bellows as claimed in claim 7, wherein the elastomer matrix has a third material composition.

10. The hybrid bellows as claimed in claim 9, wherein the third material composition is substantially identical to the first material composition or the third material composition is substantially identical to the second material composition.

11. The hybrid bellows as claimed in claim 7, wherein each rigidity support layer comprises a plurality of rigidity supports.

12. The hybrid bellows as claimed in claim 11, wherein the rigidity supports are fibers made of polyamide and/or polyester or a woven fabric made of polyamide and/or polyester.

13. The hybrid bellows as claimed in claim 1, wherein the working chamber which is to be shaped by the main body is fluid-tight.

14. A height adjustment device for a vehicle, comprising two hybrid bellows as claimed claim 1, a first wall element and a second wall element axially spaced apart from the first wall element, wherein the first wall element, the second wall element and the two hybrid bellows form a working chamber.

15. The height adjustment device as claimed in claim 14, wherein the height adjustment device is a hydraulically operating height adjustment device.

16. A system for the height adjustment of a vehicle, comprising a height adjustment device as claimed in claim 14, a first spring support, a second spring support and a spring arranged between the first spring support and the second spring support.
